(19) United States
(12) Patent Application Publication
(10) Pub. No.: US 2024/0384131 A1
(43) Pub. Date: Nov. 21, 2024

(54) MULTIFUNCTIONAL MODIFIED SILANE COMPOUND AND MANUFACTURE METHOD THEREOF, HARDENED COATING LAYER AND MANUFACTURE METHOD THEREOF

(71) Applicant: SHENZHEN CHINA STAR OPTOELECTRONICS SEMICONDUCTOR DISPLAY TECHNOLOGY CO., LTD., Shenzhen (CN)

(72) Inventor: Aibing BAO, Shenzhen (CN)

(21) Appl. No.: 18/522,368

(22) Filed: Nov. 29, 2023

(30) Foreign Application Priority Data
May 18, 2023 (CN) 202310565866.6

(51) Int. Cl. C09D 183/08; C08G 77/06; C08G 77/24

(52) U.S. Cl. CPC C09D 183/08; C08G 77/06; C08G 77/24; C08G 2150/00

(57) ABSTRACT

A multifunctional modified silane compound and a manufacture method thereof, as well as a hardened coating layer and a manufacture method thereof are provided. Material of a hardened coating layer includes a multifunctional modified silane compound including R1, R2, R3 and R4. R1 includes a cyclic rigid structure, R2 includes a fluorine-containing structure, R3 includes a polar group, and R4 includes a polyfunctional (meth)acrylate having three or more (meth)acryloyloxy groups.

### CROSS-REFERENCE TO RELATED APPLICATION

This application claims priority to and the benefit of Chinese Patent Application No. 202310565866.6, filed on May 18, 2023, the disclosure of which is incorporated herein by reference in its entirety.

### TECHNICAL FIELD

The present disclosure relates to the field of materials, and more particularly, to a multifunctional modified silane compound and a manufacture method thereof, as well as a hardened coating layer and a manufacture method thereof.

### BACKGROUND

The display device may convert data of a computer into various characters, numbers, symbols, or visual images for display, and may input commands or data to the computer by using an input tool such as a keyboard. And, the display device may also add, delete, and convert the display contents at any time by means of hardware and software of the system. The display device is classified into a plasma type, a liquid crystal type, a light-emitting diode type, a cathode-ray tube type, and the like according to display elements used by this display device.

The display is scratched during usage, and therefore a display surface thereof is required to be scratch-resistant, high-hardness and friction-resistant. At the same time, the display may be contaminated during usage, and the contaminants are not easily removed. If a solvent is used to erase the display, the surface of the display may be damaged. Therefore, it is desirable to enable a surface of the display to have antifouling properties and water repellent properties.

In order to make the surface of the display have high mechanical properties and anti-fouling properties at the same time, there are generally two methods. A first method is to add a fluorine-containing auxiliary agent to the hardened coating layer. Although good mechanical properties can be obtained, since the fluorine content of the hardened coating layer is low, the anti-fouling and hydrophobic effect is limited, and a water contact angle is difficult to exceed 110°. A second method is to apply organosilicon or fluorocarbon material on the surface of the display to cure into a film. However, such a film is not highly cross-linked and it is difficult for this film to have good mechanical properties.

### SUMMARY

An object of the present disclosure is to provide a multifunctional modified silane compound and a manufacture method thereof, as well as a hardened coating layer and a manufacture method thereof, which can solve problems in the related art, such as a limited anti-fouling and hydrophobic effect in a case where a fluorine-containing auxiliary agent is added to the hardened coating layer to improve mechanical properties, and poor mechanical properties of a film cured by using organosilicon or fluorocarbon material.

To solve the above problems, in some embodiments, a multifunctional modified silane compound is provided, and includes:

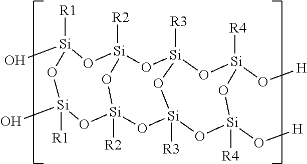

where R1 includes a cyclic rigid structure, R2 includes a fluorine-containing structure, R3 includes a polar group, and R4 includes a polyfunctional (meth) acrylate having three or more (meth)acryloyloxy groups.

Further, R1 includes one of formulae:

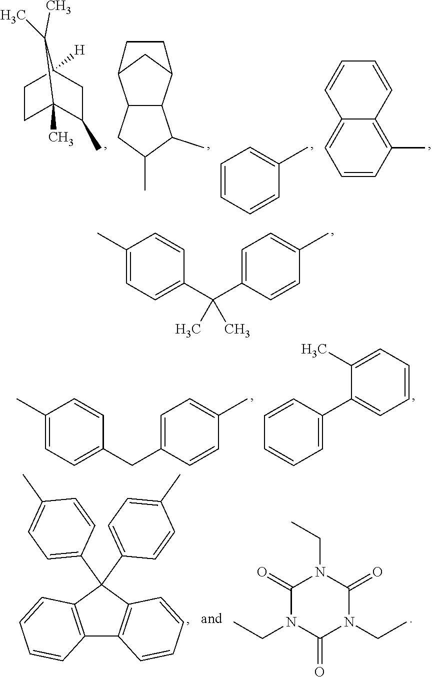

Further, R2 includes one of formulae:

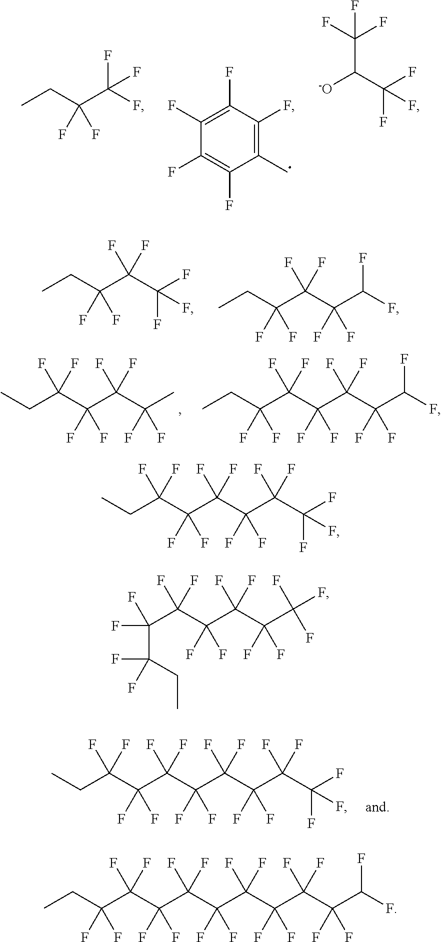

Further, R3 includes one of formulae:

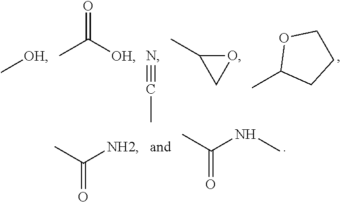

In order to solve the above problem, a manufacture method for a multifunctional modified silane compound is also provided, and includes: adding a first vinyl group-containing siloxane, a cyclic structure-containing acrylate, and first photoinitiator to a first container, introducing first nitrogen into the first container and stirring, and reacting the first nitrogen with the first vinyl group-containing siloxane, the cyclic structure-containing acrylate and the first photoinitiator under first light to form a first reaction solution; adding a second vinyl group-containing siloxane, a fluoroalkyl acrylate, and second photoinitiator to a second container, introducing second nitrogen into the second container and stirring, and reacting the second nitrogen with the second vinyl group-containing siloxane, the fluoroalkyl acrylate, and the second photoinitiator under second light to form a second reaction solution; adding a third vinyl group-containing siloxane, a polar group-containing propene, and third photoinitiator to a third container, introducing third nitrogen into the third container and stirring, and reacting the third nitrogen with the third vinyl group-containing siloxane, the polar group-containing propene, and the third photoinitiator under third light to form a third reaction solution; adding a fourth vinyl group-containing siloxane, an acrylate having a functionality of three or more, and fourth photoinitiator to a fourth container, introducing fourth nitrogen into the fourth container and stirring, and reacting the fourth nitrogen with the fourth vinyl group-containing siloxane, the acrylate having a functionality of three or more, and the fourth photoinitiator under fourth light to form a fourth reaction solution; adding potassium carbonate (K₂CO₃), first ultrapure water, and tetrahydrofuran to a fifth container to form a first mixture, adding the first reaction solution, the second reaction solution, the third reaction solution, and the fourth reaction solution to the first mixture to form a second mixture, stirring the second mixture, and decomposing the second mixture into a colorless aqueous phase and a cloudy organic phase; and evaporating organic solvent in the cloudy organic phase, dissolving a remaining portion of the second mixture into Dichloromethane (DCM), and extracting multiple times by using second ultrapure water to evaporate to obtain the multifunctional modified silane compound.

Further, each of the first vinyl group-containing siloxane, the second vinyl group-containing siloxane, the third vinyl group-containing siloxane, and the fourth vinyl group-containing siloxane includes one of vinyltrimethoxysilane, 3-methacryloyloxypropyltrimethoxysilane, 3-(acryloyloxy)propyltrimethoxysilane, vinyl tris(2-methoxyethoxy) silane, Triethoxyvinylsilane, vinylmethyldimethoxysilane, diethoxy(methyl)vinylsilane, tetrakis(vinyldimethylsiloxy)silane, methylbis (trimethylsiloxy)vinylsilane, vinyl tris(trimethylsiloxy)silane, (4-ethenylphenyl) trimethoxy-silane, vinyl tris(dimethylsiloxy)silane, tri(isopropoxy)vinylsilane, and triethoxy(1-phenylvinyl)silane.

Further, the cyclic structure-containing acrylate includes one of isobornyl acrylate, isobornyl methacrylate, tricyclodecane dimethanol diacrylate, 2-phenoxyethyl acrylate, fluorene-based acrylate, triallyl trimellitate, bisphenol-A diacrylate, ethoxylated (10) bisphenol A diacrylate, bisphenol F diacrylate, ethoxylated bisphenol F diacrylate, 2-Propenoic acid 2-([1,1′-biphenyl]-2-yloxy)ethyl ester, benzyl phenoxy acrylate, bisphenol fluorene diacrylate, 9,9-bis[4-(2-acryloyl-oxyethyloxy)phenyl] fluorene, and 1,3,5-Tri-2-propenyl-1,3,5-triazine-2,4,6 (1H,3H,5H)-trione.

Further, the fluoroalkyl acrylate includes one of 1H,1H-perfluorooctylacrylate, 1H,1H-heptafluorobutyl methacrylate, 1H,1H, 5H-octafluoropentyl acrylate, 2-(perfluoroalkyl)ethyl methacrylate, 1H,1H-heptafluorobutyl acrylate, 1H,1H,7H-dodecafluoroheptyl acrylate, 2-(perfluorooctyl)ethyl methacrylate, 1H,1H,2H,2H-perfluorooctyl acrylate, 1H,1H-pentafluoropropyl methacrylate, 1,1,1,3,3,3-hexafluoroisopropyl acrylate, 2,2,3,3-tetrafluoropropyl methacrylate, 2,2,3,3,4,4,5,5-octafluoro-1,6-hexanediol diacryl, 2,3,4,5,6-pentafluorostyrene, 3-perfluorohexyl-2-hydroxypropyl acrylate, 2,2,2-trifluoroethyl acrylate, 1H,1H,11H-perfluoroundecyl methacrylate, and 1H,1H,7H-dodecafluoroheptyl methacrylate.

Further, the polar group-containing propene includes one of 2-hydroxyethyl acrylate, 2-hydroxyethyl methacrylate, hydroxypropyl acrylate, 2-hydroxypropyl methacrylate, 4-hydroxybutyl acrylate, 2-hydroxy-3-phenoxypropyl acrylate, glyceryl monomethacrylate, acrylic acid, 2-hydroxyethyl acrylate, acrylonitrile, ethyl 2-cyanoacrylate, enbucrilate, methyl alpha-cyanocinnamate, ethyl (ethoxymethylene)cyanoacetate, 2-cyanoethyl acrylate, glycidyl acrylate, tetrahydrofurfuryl acrylate, 3-(2-furyl)acrylic acid, 2-acetamidoacrylic acid, acrylamide, methacrylamide, diacetone acrylamide, N,N-dimethylaminopropyl acrylamide, N-tert-butylacrylamide, N-methylolacrylamide, N-ethyl acrylamide, N-acryloyltris(hydroxymethyl)aminomethane, and N,N′-methylenebisacrylamide.

Further, the acrylate having a functionality of three or more includes one of trimethylolethane tri(meth)acrylate, trimethylolpropane trimethacrylate, glycerol trimethacrylate, pentaerythritoltri (meth) acrylate, di(trimethylolpropane) tri(meth)acrylate, dipentaerythritol tri(meth)acrylate, pentaerythritol tetrakis(meth) acrylate, di(trimethylolpropane) tetrakis(meth)acrylate, dipentaerythritol tetra(meth)acrylate, dipentaerythritol penta(meth)acrylate, di(trimethylolpropane) penta(meth)acrylate, dipentaerythritol hexaacrylate, and di(trimethylolpropane) hexa(meth)acrylate.

In order to solve the above problems, the present disclosure also provides a hardened coating layer, material of which is measured in parts by weight, including: 90 to 100 parts of the multifunctional modified silane compounds mentioned above; 5 to 10 parts of photoinitiator; and 900 to 9000 parts of first solvent having a boiling point range of 50° C.-150° C.

Further, the photoinitiator includes one of 2-hydroxyacetophenone, alkylaminoacetophenone, benzoin ether, a phosphine oxide compound, benzyl ketal, and dialkoxy phenylethyl ketone photosensitizer.

Further, the first solvent having the boiling point range of 50° C.-150° C. includes one of an alcohol solvent, an ester solvent, a ketone solvent, and a benzene solvent.

In order to solve the above problem, the present disclosure also provides a method for manufacturing a hardened coating layer mentioned above, which includes: mixing the multifunctional modified silane compound, the photoinitiator, and the first solvent having the boiling point range of 50° C.-150° C. to form a hardened coating liquid, and manufacturing the hardened coating liquid on a substrate to form the hardened coating layer.

The present disclosure has following advantages. The material of the hardened coating layer of the present disclosure includes a multifunctional modified silane compound including R1, R2, R3 and R4. R1 includes a cyclic rigid structure, R2 includes a fluorine-containing structure, R3 includes a polar group, and R4 includes a polyfunctional (meth)acrylate having three or more (meth)acryloyloxy groups. The formed hardened coating layer has very good mechanical properties, the pencil hardness of the formed hardened coating layer is less than or equal to 4 H, and the steel wool abrasion resistance of the formed hardened coating layer is greater than or equal to 100 cycles, through the cyclic rigid structure of R1 and the network crosslinking of R4. The formed hardened coating layer has a very good antifouling and water repellent effect via the perfluoro structure of R2, and a water contact angle of the formed hardened coating layer is greater than or equal to 115°. The adhesion force between the formed hardened coating layer and the substrate can be increased by the polar groups of R3, and the adhesion force 5 B can be tested using the Baigua method.

### DETAILED DESCRIPTION

The following detailed description of preferred embodiments of the present disclosure is made to provide those skilled in the art with a complete description of the technical contents of the present disclosure, so as to exemplify that the present disclosure may be practiced. So, the technical contents of the present disclosure will be more apparent to those skilled in the art that how the present disclosure may be practiced. The disclosure may, however, be embodied in many different forms of embodiments, the protection scope of the disclosure is not limited to the embodiments mentioned herein, and the following description of the embodiments is not intended to limit the scope of the disclosure.

### Example 1

The present disclosure provides a multifunctional modified silane compound, and includes:

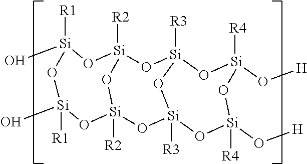

where R1 includes a cyclic rigid structure, R2 includes a fluorine-containing structure, R3 includes a polar group, and R4 includes a polyfunctional (meth)acrylate having three or more (meth)acryloyloxy groups.

R1 includes one of formulae:

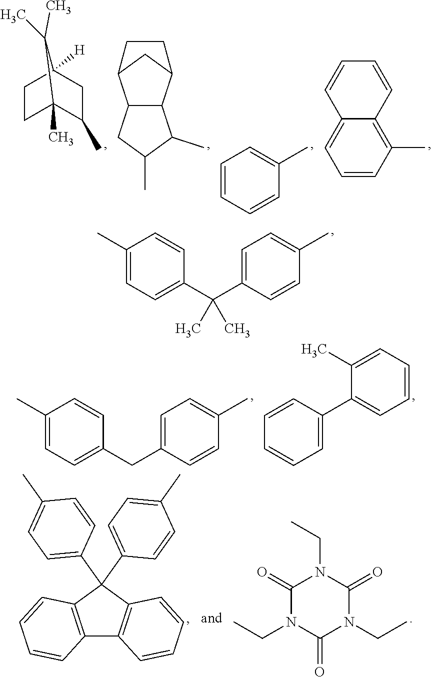

R2 includes one of formulae:

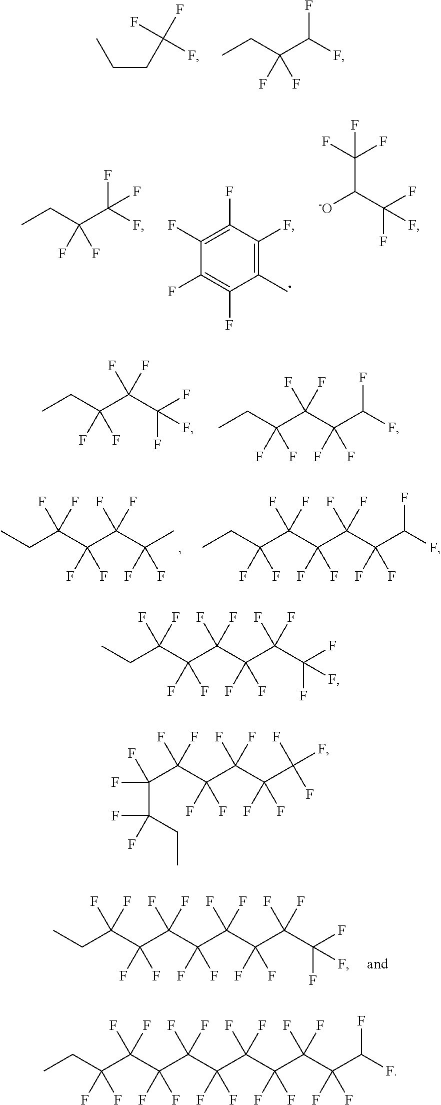

R3 includes one of formulae:

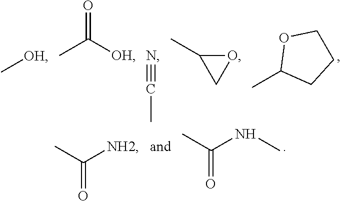

In order to solve the above problem, a manufacture method for a multifunctional modified silane compound is also provided, and includes steps S1 to S5. At step S1, a first vinyl group-containing siloxane, a cyclic structure-containing acrylate, and first photoinitiator are added to a first container, first nitrogen is introduced into the first container and stirred, and the first nitrogen is reacted with the first vinyl group-containing siloxane, the cyclic structure-containing acrylate and the first photoinitiator under first light to form a first reaction solution. At step S2, a second vinyl group-containing siloxane, a fluoroalkyl acrylate, and second photoinitiator are added to a second container, second nitrogen is introduced into the second container and stirred, and the second nitrogen is reacted with the second vinyl group-containing siloxane, the fluoroalkyl acrylate, and the second photoinitiator under second light to form a second reaction solution. At step S3, a third vinyl group-containing siloxane, a polar group-containing propene, and third photoinitiator are added to a third container, third nitrogen is introduced into the third container and stirred, and the third nitrogen is reacted with the third vinyl group-containing siloxane, the polar group-containing propene, and the third photoinitiator under third light to form a third reaction solution. At step S4, a fourth vinyl group-containing siloxane, an acrylate having a functionality of three or more, and fourth photoinitiator are added to a fourth container, fourth nitrogen is introduced into fourth container and stirred, and the fourth nitrogen is reacted with the fourth vinyl group-containing siloxane, the acrylate having a functionality of three or more, and the fourth photoinitiator under fourth light to form a fourth reaction solution. At step S5, potassium carbonate (K₂CO₃), first ultrapure water, and tetrahydrofuran are added to a fifth container to form a first mixture, the first reaction solution, the second reaction solution, the third reaction solution, and the fourth reaction solution are added to the first mixture to form a second mixture, the second mixture is stirred, and the second mixture is decomposed into a colorless aqueous phase and a cloudy organic phase; organic solvent in the cloudy organic phase is evaporated, a remaining portion of the second mixture is dissolved into Dichloromethane (DCM), and extracted a plurality of times by using second ultrapure water to evaporate to obtain the multifunctional modified silane compound.

At step S1, a reaction formula of each vinyl group-containing siloxane and the cyclic structure-containing acrylate is denoted by:

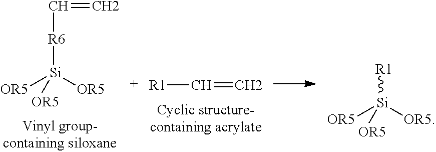

At step S1, each of the first vinyl group-containing siloxane, the second vinyl group-containing siloxane, the third vinyl group-containing siloxane, and the fourth vinyl group-containing siloxane includes one of vinyltrimethoxysilane, 3-methacryloyloxypropyltrimethoxysilane, 3-(acryloyloxy)propyltrimethoxysilane, vinyl tris(2-methoxyethoxy) silane, Triethoxyvinylsilane, vinylmethyldimethoxysilane, diethoxy(methyl)vinylsilane, tetrakis(vinyldimethylsiloxy)silane, methylbis (trimethylsiloxy)vinylsilane, vinyl tris(trimethylsiloxy)silane, (4-ethenylphenyl) trimethoxy-silane, vinyl tris(dimethylsiloxy)silane, tri(isopropoxy)vinylsilane, and triethoxy(1-phenylvinyl)silane, where R5 and R6 both include alkyl.

At step S1, the cyclic structure-containing acrylate includes one of isobornyl acrylate, isobornyl methacrylate, tricyclodecane dimethanol diacrylate, 2-phenoxyethyl acrylate, fluorene-based acrylate, triallyl trimellitate, bisphenol-A diacrylate, ethoxylated (10) bisphenol A diacrylate, bisphenol F diacrylate, ethoxylated bisphenol F diacrylate, 2-Propenoic acid 2-([1,1′-biphenyl]-2-yloxy)ethyl ester, benzyl phenoxy acrylate, bisphenol fluorene diacrylate, 9,9-bis[4-(2-acryloyl-oxyethyloxy)phenyl] fluorene, and 1,3,5-Tri-2-propenyl-1,3,5-triazine-2,4,6 (1H,3H,5H)-trione.

At step S2, a reaction formula of each vinyl group-containing siloxane and the fluoroalkyl acrylate is denoted by:

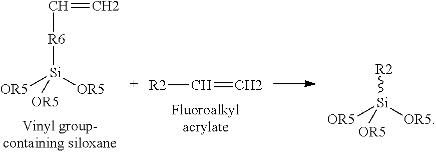

At step S2, the fluoroalkyl acrylate includes one of 1H,1H-perfluorooctylacrylate, 1H,1H-heptafluorobutyl methacrylate, 1H,1H,5H-octafluoropentyl acrylate, 2-(perluoroalkyl)ethyl methacrylate, 1H,1H-heptafluorobutyl acrylate, 1H,1H,7H-dodecafluoroheptyl acrylate, 2-(perfluorooctyl)ethyl methacrylate, 1H,1H,2H,2H-perfluorooctyl acrylate, 1H,1H-pentafluoropropyl methacrylate, 1,1,1,3,3,3-hexafluoroisopropyl acrylate, 2,2,3,3-tetrafluoropropyl methacrylate, 2,2,3,3,4,4,5,5-octafluoro-1,6-hexanediol diacryl, 2,3,4,5,6-pentafluorostyrene, 3-perfluorohexyl-2-hydroxypropyl acrylate, 2,2,2-trifluoroethyl acrylate, 1H,1H,11H-perfluoroundecyl methacrylate, and 1H,1H,7H-dodecafluoroheptyl methacrylate.

At step S3, a reaction formula of each vinyl group-containing siloxane and the polar group-containing propene is denoted by:

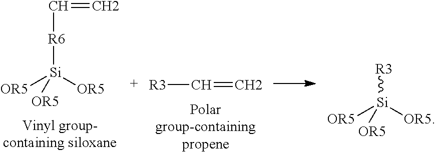

At step S3, the polar group-containing propene includes one of 2-hydroxyethyl acrylate, 2-hydroxyethyl methacrylate, hydroxypropyl acrylate, 2-hydroxypropyl methacrylate, 4-hydroxybutyl acrylate, 2-hydroxy-3-phenoxypropyl acrylate, glyceryl monomethacrylate, acrylic acid, 2-hydroxyethyl acrylate, acrylonitrile, ethyl 2-cyanoacrylate, enbucrilate, methyl alpha-cyanocinnamate, ethyl (ethoxymethylene)cyanoacetate, 2-cyanoethyl acrylate, glycidyl acrylate, tetrahydrofurfuryl acrylate, 3-(2-furyl)acrylic acid, 2-acetamidoacrylic acid, acrylamide, methacrylamide, diacetone acrylamide, N,N-dimethylaminopropyl acrylamide, N-tert-butylacrylamide, N-methylolacrylamide, N-ethyl acrylamide, N-acryloyltris(hydroxymethyl)aminomethane, and N,N′-methylenebisacrylamide.

At step S4, a reaction formula of each vinyl group-containing siloxane and the acrylate having a functionality of three or more is denoted by:

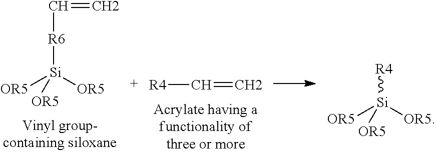

At step S4, the acrylate having a functionality of three or more includes one of trimethylolethane tri(meth)acrylate, trimethylolpropane trimethacrylate, glycerol trimethacrylate, pentaerythritoltri (meth) acrylate, di(trimethylolpropane) tri(meth)acrylate, dipentaerythritol tri(meth)acrylate, pentaerythritol tetrakis(meth) acrylate, di(trimethylolpropane) tetrakis(meth)acrylate, dipentaerythritol tetra(meth)acrylate, dipentaerythritol penta(meth)acrylate, di(trimethylolpropane) penta(meth)acrylate, dipentaerythritol hexaacrylate, and di(trimethylolpropane) hexa(meth)acrylate.

At step S5, a reaction formula of K₂CO₃, the ultrapure water, the photoinitiator, the first reaction solution, the second reaction solution, the third reaction solution, and the fourth reaction solution is denoted by:

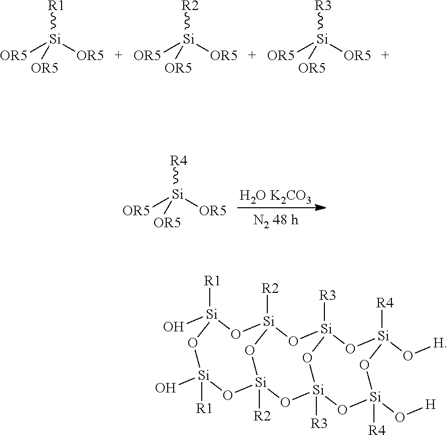

In this example, at step S1, 10 g of 3-methacryloxypropyltrimethoxysilane, 8.95 g of isobornyl methacrylate, 0.5 g of ethyl (2,4,6-trimethylbenzoyl) phenylphosphonate are added into a first flask (a three-necked flask), nitrogen is introduced into the first flask and stirred, and the reaction of them is carried out under LED light having a wavelength of 365 nm for 1 h to form a first reaction solution. That is, the vinyl-containing siloxane in this example is 3-methacryloxypropyltrimethoxysilane, the cyclic structure-containing acrylic acid is isobornyl methacrylate, and the photoinitiator is a phosphine oxide compound. Specifically, the photoinitiator is ethyl (2,4,6-trimethylbenzoyl) phenylphosphonate.

In this example, at step S2, 10 g of 3-methacryloxypropyltrimethoxysilane, 15.55 g of 1H,1H,7H-dodecafluoroheptyl acrylate, and 0.8 g of ethyl (2,4,6-trimethylbenzoyl) phenylphosphinate are added into a second flask (three-necked flask), nitrogen is introduce into the second flask and stirred, and the reaction of them is carried out under LED light having a wavelength of 365 nm for 2 h to form a second reaction solution. That is, the vinyl-containing siloxane in this example is 3-methacryloxypropyltrimethoxysilane, the fluoroalkyl acrylate is 1H,1H,7H-dodecafluoroheptyl acrylate, and the photoinitiator is a phosphine oxide compound. Specifically, the photoinitiator is ethyl (2,4,6-trimethylbenzoyl)phenylphosphonate.

In this example, at step S3, 10 g of 3-methacryloxypropyltrimethoxysilane, 6.29 g of tetrahydrofurfuryl acrylate, and 0.5 g of ethyl (2,4,6-trimethylbenzoyl) phenylphosphinate are added in a third flask (three-necked flask), the nitrogen is introduced into the third flask and stirred, and the reaction of them is carried out under LED light having a wavelength of 365 nm for 1 h to form a third reaction solution. That is, the vinyl-containing siloxane in this example is 3-methacryloxypropyltrimethoxysilane, the polar group-containing propylene is tetrahydrofurfuryl acrylate, and the photoinitiator is a phosphine oxide compound. Specifically, the photoinitiator is ethyl (2,4,6-trimethylbenzoyl)phenylphosphonate.

In this example, at step S4, 10 g of 3-methacryloxypropyltrimethoxysilane, 13.63 g of trimethylolpropane trimethacrylate, and 0.6 g of ethyl (2,4,6-trimethylbenzoyl) phenylphosphinate are added into a fourth flask (three-necked flask), the nitrogen is introduced into fourth flask and stirred, and the reaction of them is carried out under LED light having a wavelength of 365 nm for 1 h to form a fourth reaction solution. That is, the vinyl-containing siloxane in this example is 3-methacryloxypropyltrimethoxysilane, the acrylate having a functionality of three or more is trimethylolpropane trimethacrylate, and the photoinitiator is a phosphine oxide compound. Specifically, the photoinitiator is ethyl (2,4,6-trimethylbenzoyl) phenylphosphonate.

In this example, at step S5, 0.1 g of K₂CO₃, 9 g of ultrapure water, and 15 g of tetrahydrofuran are added to a fourth flask (250 mL of bottom flask with a round bottom) to form a first mixture. 12 g of the first reaction solution, 12 g of the second reaction solution, 12 g of the third reaction solution, and 4 g of the fourth reaction solution are added to the first mixture introduced with nitrogen, so as to form a second mixture. The second mixture is vigorously stirred at room temperature for 48 h. The second mixture is then decomposed into a cloudy organic phase containing the product and a colorless aqueous phase. The organic solvent in the cloudy organic phase is removed by evaporation and the remaining white viscous solution was dissolved in DCM and extracted multiple times by using the ultrapure water. To remove traces of moisture in the DCM solution, MgSO₄ is added as a drying agent and the DCM solution is stirred and stayed overnight before filtration. Subsequently, DCM is evaporated at 40° C. for 2 h to obtain the multifunctional modified silane compound as a clear oil.

The present example also provides a hardened coating layer, material of which is measured in parts by weight, including 90-100 parts of the multifunctional modified silane compound described in the present example; 5 to 10 parts of photoinitiator; and 900˜9000 parts of first solvent having a boiling point in a range of 50° C.-150° C.

In this example, the cyclic rigid structure of R1 and the networked cross-linking of R4 make the formed hardened coating layer to possess very good mechanical properties, e.g., the pencil hardness of the hardened coating layer is greater than or equal to 4 H, and the steel wool abrasion resistance of the hardened coating layer is greater than or equal to 100 cycles. The perfluoro structure of R2 makes the formed hardened coating layer to possess a very good antifouling and water repellent effect, e.g., a water contact angle of the formed hardened coating layer is greater than or equal to 115°. The adhesion force between the formed hardened coating layer and the substrate can be increased by the polar groups of R3, and the adhesion force 5 B can be tested using the Baigua method.

The photoinitiator includes one of 2-hydroxyacetophenone, alkylaminoacetophenone, benzoin ether, a phosphine oxide compound, benzyl ketal, and dialkoxy phenylethyl ketone photosensitizer.

The boiling point of the first solvent is below 50° C. to possess a strong volatility, so the resin content and the thickness of the coating layer are affected, and the drying process above 150° C. becomes difficult, thereby affecting the efficiency and increasing the costs. The first solvent having a boiling point range of 50° C.-150° C. includes one of an alcohol solvent, an ester solvent, a ketone solvent, and a benzene solvent.

The alcohol solvent includes one of methanol, ethanol and isopropanol. The ester solvent includes one of ethyl acetate, propyl acetate, and butyl acetate. The ketone solvent includes one of acetone, butanone, and cyclohexanone. The benzene solvent includes one of toluene and xylene.

The present example also provides a method for manufacturing a hardened coating layer according to the present example. The method includes: the multifunctional modified silane compound, the photoinitiator, and the first solvent having a boiling point range of 50° C.-150° C. are mixed to form a hardened coating liquid, and the hardened coating liquid is manufactured on a substrate to form the hardened coating layer.

Specifically, in the present example, 10 g of the multifunctional modified silane compound, 0.3 g of ethyl (2,4,6-trimethylbenzoyl) phenylphosphinate, and 19 g of ethyl acetate are mixed to form a hardened coating liquid, and the hardened coating liquid is manufactured on a polyethylene glycol terephthalate (PET) substrate and formed into a hardened coating layer by using a bar coater. That is, the photoinitiator is the phosphine oxide compound. Specifically, the photoinitiator is ethyl (2,4,6-trimethylbenzoyl)phenylphosphinate. A thickness of the formed hardened coating layer is 3 μm.

The hardened coating layer manufactured in this example is tested and possesses the pencil hardness: 5 H; the steel wool friction: 150 cycles; the water contact angle: 123°; and the adhesion force: 5 B.

Thus, the hardened coating layer of the present example has very good mechanical properties, e.g., the pencil hardness is greater than or equal to 4 H, and the steel wool abrasion resistance is greater than or equal to 100 cycles. The hardened coating layer has a very good anti-fouling and water-repellent effect with the water contact angle of ≥115°. The adhesion force between the hardened coating layer and the substrate is good, and the adhesion force 5 B is tested by using the Baigua method.

### Example 2

The present example includes most of the technical features of Example 1. The present example differs from Example 1 in that, in the present example, at step S1, 10 g of 3-methacryloxypropyltrimethoxysilane, 8.95 g of tricyclodecane dimethanol diacrylate, 0.7 g of 1-hydroxycyclohexyl phenyl ketone are added into a first flask (a three-necked flask), nitrogen is introduced into the first flask and stirred, and the reaction of them is carried out under LED light having a wavelength of 365 nm for 1 h to form a first reaction solution. That is, the first compound in this example is 3-methacryloxypropyltrimethoxysilane, the second compound is tricyclodecane dimethanol diacrylate, and the photoinitiator is hydroxyphenylacetone. Specifically, the photoinitiator is 1-hydroxycyclohexyl phenyl ketone.

In this example, at step S2, 10 g of 3-methacryloxypropyltrimethoxysilane, 17.84 g of 1H,1H,2H,2H-perfluorooctyl acrylate, and 0.6 g of 1-hydroxycyclohexyl phenyl ketone are added into a second flask (three-necked flask), nitrogen is introduce into the second flask and stirred, and the reaction of them is carried out under LED light having a wavelength of 365 nm for 2 h to form a second reaction solution. That is, the first compound in this example is 3-methacryloxypropyltrimethoxysilane, the third compound is 1H,1H,2H,2H-perfluorooctyl acrylate, and the photoinitiator is hydroxyphenylacetone. Specifically, the photoinitiator is 1-hydroxycyclohexyl phenyl ketone.

In this example, at step S3, 10 g of 3-methacryloxypropyltrimethoxysilane, 6.15 g of 4-hydroxybutyl acrylate, and 0.5 g of 1-hydroxycyclohexyl phenyl ketone are added in a third flask (three-necked flask), the nitrogen is introduced into the third flask and stirred, and the reaction of them is carried out under LED light having a wavelength of 365 nm for 1 h to form a third reaction solution. That is, the first compound in this example is 3-methacryloxypropyltrimethoxysilane, the fourth compound is 4-hydroxybutyl acrylate, and the photoinitiator is hydroxyphenylacetone. Specifically, the photoinitiator is 1-hydroxycyclohexyl phenyl ketone.

In this example, at step S4, 10 g of 3-methacryloxypropyltrimethoxysilane, 30.07 g of dipentaerythritol hexaacrylate, and 0.8 g of 1-hydroxycyclohexyl phenyl ketone are added into a fourth flask (three-necked flask), the nitrogen is introduced into fourth flask and stirred, and the reaction of them is carried out under LED light having a wavelength of 365 nm for 1 h to form a fourth reaction solution. That is, the first compound in this example is 3-methacryloxypropyltrimethoxysilane, the fifth compound is dipentaerythritol hexaacrylate, and the photoinitiator is hydroxyphenylacetone. Specifically, the photoinitiator is 1-hydroxycyclohexyl phenyl ketone.

In this example, at step S5, 0.1 g of K₂CO₃, 9 g of ultrapure water, and 15 g of the second solvent (tetrahydrofuran) are added to a fourth flask (250 mL of bottom flask with a round bottom) to form a first mixture. 12 g of the first reaction solution, 12 g of the second reaction solution, 12 g of the third reaction solution, and 4 g of the fourth reaction solution are added to the first mixture introduced with nitrogen, so as to form a second mixture. The second mixture is vigorously stirred at room temperature for 48 h. The second mixture is then decomposed into a cloudy organic phase containing the product and a colorless aqueous phase. The organic solvent in the cloudy organic phase is removed by evaporation, and the remaining white viscous solution was dissolved in the third solvent (i.e., DCM) and extracted multiple times by using the ultrapure water. To remove traces of moisture in the DCM solution, MgSO₄ is added as a drying agent and the DCM is stirred and stayed overnight before filtration. Subsequently, DCM is evaporated at 40° C. for 2 h to obtain the multifunctional modified silane compound as a clear oil.

In this example, at step S6, 10 g of the multifunctional modified silane compound, 0.3 g of 1-hydroxycyclohexyl phenyl ketone, and 19 g of isopropyl alcohol are mixed to form a hardened coating liquid, and the hardened coating liquid is manufactured on a PET substrate by using a bar coater to form a hardened coating layer. Specifically, the photoinitiator is 1-hydroxycyclohexyl phenyl ketone. The thickness of the formed hardened coating layer is 3 μm.

The hardened coating layer manufactured in this example is tested and possesses pencil hardness: 6 H; the steel wool friction: 200 cycles; the water contact angle: 125°; and the adhesion force: 5 B.

It can be seen that the hardened coating layer of this example has very good mechanical properties, e.g., the pencil hardness is greater than or equal to 4 H, the steel wool abrasion resistance is greater than or equal to 100 cycles. The hardened coating layer has a very good anti-fouling and water-repellent effect with a water contact angle of ≥115°. The adhesion force between the hardened coating layer and the substrate is good, and the adhesion force 5 B was tested by using the Baigua method.

Further, the multifunctional modified silane compound and the manufacture method thereof, the hardened coating layer and the manufacture method thereof provided herein are described in detail above, and the principles and implements are described herein using specific examples. The description in the above examples is merely provided to help understand the method and core teachings of the present disclosure. At the same time, variations will occur to those skilled in the art in both the detailed description and the scope of application in accordance with the teachings of the present disclosure. In view of the foregoing, the present description should not be construed as limiting the disclosure.

What is claimed is:

1. A multifunctional modified silane compound, comprising: 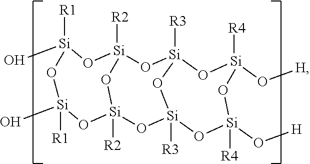
wherein R1 comprises a cyclic rigid structure, R2 comprises a fluorine-containing structure, R3 comprises a polar group, and R4 comprises a polyfunctional (meth)acrylate having three or more (meth)acryloyloxy groups.

2. The multifunctional modified silane compound according to claim 1, wherein the R1 comprises one of formulae:

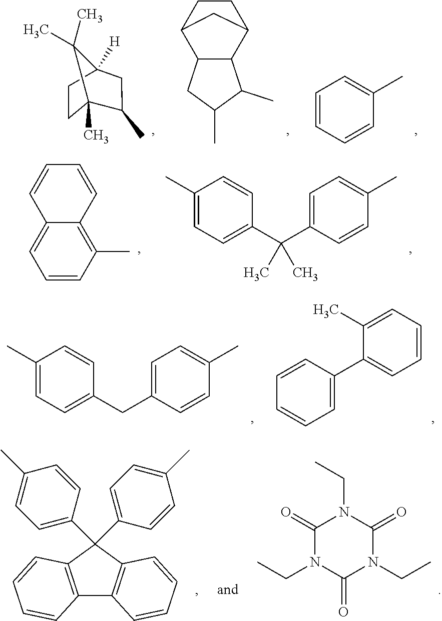

3. The multifunctional modified silane compound according to claim 1, wherein the R2 comprises one of formulae:

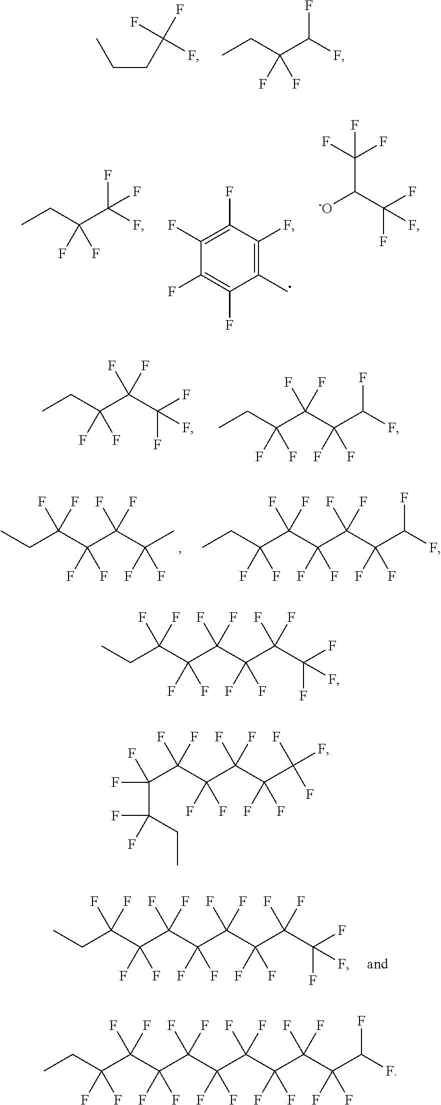

4. The multifunctional modified silane compound according to claim 1, wherein the R3 comprises one of formulae:

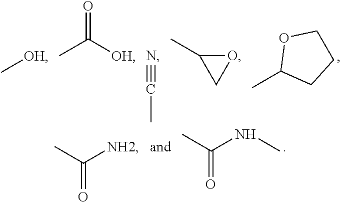

5. A manufacture method for the multifunctional modified silane compound according to claim 1, comprising:
adding a first vinyl group-containing siloxane, a cyclic structure-containing acrylate, and first photoinitiator to a first container, introducing first nitrogen into the first container and stirring, and reacting the first nitrogen with the first vinyl group-containing siloxane, the cyclic structure-containing acrylate and the first photoinitiator under first light to form a first reaction solution;
adding a second vinyl group-containing siloxane, a fluoroalkyl acrylate, and second photoinitiator to a second container, introducing second nitrogen into the second container and stirring, and reacting the second nitrogen with the second vinyl group-containing siloxane, the fluoroalkyl acrylate, and the second photoinitiator under second light to form a second reaction solution;
adding a third vinyl group-containing siloxane, a polar group-containing propene, and third photoinitiator to a third container, introducing third nitrogen into the third container and stirring, and reacting the third nitrogen with the third vinyl group-containing siloxane, the polar group-containing propene, and the third photoinitiator under third light to form a third reaction solution;
adding a fourth vinyl group-containing siloxane, an acrylate having a functionality of three or more, and fourth photoinitiator to a fourth container, introducing fourth nitrogen into the fourth container and stirring, and reacting the fourth nitrogen with the fourth vinyl group-containing siloxane, the acrylate having a functionality of three or more, and the fourth photoinitiator under fourth light to form a fourth reaction solution;
adding potassium carbonate (K₂CO₃), first ultrapure water, and tetrahydrofuran to a fifth container to form a first mixture, adding the first reaction solution, the second reaction solution, the third reaction solution, and the fourth reaction solution to the first mixture to form a second mixture, stirring the second mixture, and decomposing the second mixture into a colorless aqueous phase and a cloudy organic phase; and
evaporating organic solvent in the cloudy organic phase, dissolving a remaining portion of the second mixture into Dichloromethane (DCM), and extracting a plurality of times by using second ultrapure water to evaporate to obtain the multifunctional modified silane compound.

6. The manufacture method according to claim 5, wherein each of the first vinyl group-containing siloxane, the second vinyl group-containing siloxane, the third vinyl group-containing siloxane, and the fourth vinyl group-containing siloxane comprises one of: vinyltrimethoxysilane, 3-methacryloyloxypropyltrimethoxysilane, 3-(acryloyloxy)propyltrimethoxysilane, vinyl tris(2-methoxyethoxy) silane, Triethoxyvinylsilane, vinylmethyldimethoxysilane, diethoxy(methyl)vinylsilane, tetrakis(vinyldimethylsiloxy)silane, methylbis (trimethylsiloxy)vinylsilane, vinyl tris(trimethylsiloxy)silane, (4-ethenylphenyl) trimethoxy-silane, vinyl tris(dimethylsiloxy)silane, tri(isopropoxy)vinylsilane, and triethoxy(1-phenylvinyl)silane.

7. The manufacture method according to claim 5, wherein the cyclic structure-containing acrylate comprises one of isobornyl acrylate, isobornyl methacrylate, tricyclodecane dimethanol diacrylate, 2-phenoxyethyl acrylate, fluorene-based acrylate, triallyl trimellitate, bisphenol-A diacrylate, ethoxylated (10) bisphenol A diacrylate, bisphenol F diacrylate, ethoxylated bisphenol F diacrylate, 2-Propenoic acid 2-([1,1′-biphenyl]-2-yloxy)ethyl ester, benzyl phenoxy acrylate, bisphenol fluorene diacrylate, 9,9-bis[4-(2-acryloyl-oxyethyloxy)phenyl] fluorene, and 1,3,5-Tri-2-propenyl-1,3,5-triazine-2,4,6 (1H,3H,5H)-trione.

8. The manufacture method according to claim 5, wherein the fluoroalkyl acrylate comprises one of 1H,1H-perfluorooctylacrylate, 1H,1H-heptafluorobutyl methacrylate, 1H,1H,5H-octafluoropentyl acrylate, 2-(perfluoroalkyl)ethyl methacrylate, 1H,1H-heptafluorobutyl acrylate, 1H,1H,7H-dodecafluoroheptyl acrylate, 2-(perfluorooctyl)ethyl methacrylate, 1H,1H,2H,2H-perfluorooctyl acrylate, 1H,1H-pentafluoropropyl methacrylate, 1,1,1,3,3,3-hexafluoroisopropyl acrylate, 2,2,3,3-tetrafluoropropyl methacrylate, 2,2,3,3,4,4,5,5-octafluoro-1,6-hexanediol diacryl, 2,3,4,5,6-pentafluorostyrene, 3-perfluorohexyl-2-hydroxypropyl acrylate, 2,2,2-trifluoroethyl acrylate, 1H,1H,11H-perfluoroundecyl methacrylate, and 1H,1H,7H-dodecafluoroheptyl methacrylate.

9. The manufacture method according to claim 5, wherein the polar group-containing propene comprises one of 2-hydroxyethyl acrylate, 2-hydroxyethyl methacrylate, hydroxypropyl acrylate, 2-hydroxypropyl methacrylate, 4-hydroxybutyl acrylate, 2-hydroxy-3-phenoxypropyl acrylate, glyceryl monomethacrylate, acrylic acid, 2-hydroxyethyl acrylate, acrylonitrile, ethyl 2-cyanoacrylate, enbucrilate, methyl alpha-cyanocinnamate, ethyl (ethoxymethylene)cyanoacetate, 2-cyanoethyl acrylate, glycidyl acrylate, tetrahydrofurfuryl acrylate, 3-(2-furyl)acrylic acid, 2-acetamidoacrylic acid, acrylamide, methacrylamide, diacetone acrylamide, N,N-dimethylaminopropyl acrylamide, N-tert-butylacrylamide, N-methylolacrylamide, N-ethyl acrylamide, N-acryloyltris(hydroxymethyl)aminomethane, and N,N′-methylenebisacrylamide.

10. The manufacture method according to claim 5, wherein the acrylate having a functionality of three or more comprises one of trimethylolethane tri(meth)acrylate, trimethylolpropane trimethacrylate, glycerol trimethacrylate, pentaerythritoltri (meth) acrylate, di(trimethylolpropane) tri(meth)acrylate, dipentaerythritol tri(meth)acrylate, pentaerythritol tetrakis(meth) acrylate, di(trimethylolpropane) tetrakis(meth)acrylate, dipentaerythritol tetra(meth)acrylate, dipentaerythritol penta(meth)acrylate, di(trimethylolpropane) penta(meth)acrylate, dipentaerythritol hexaacrylate, and di(trimethylolpropane) hexa(meth)acrylate.

11. A hardened coating layer, material of the hardened coating layer being measured in parts by weight, the hardened coating layer comprising:
90 to 100 parts of multifunctional modified silane compounds each comprising: 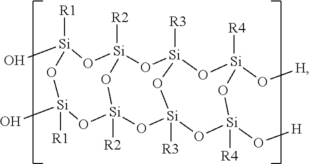
wherein R1 comprises a cyclic rigid structure, R2 comprises a fluorine-containing structure, R3 comprises a polar group, and R4 comprises a polyfunctional (meth) acrylate having three or more (meth) acryloyloxy groups;
5 to 10 parts of photoinitiator; and
900 to 9000 parts of first solvent having a boiling point range of 50° C.-150° C.

12. The hardened coating layer according to claim 11, wherein the photoinitiator comprises one of 2-hydroxyacetophenone, alkylaminoacetophenone, benzoin ether, a phosphine oxide compound, benzyl ketal, and dialkoxy phenylethyl ketone photosensitizer.

13. The hardened coating layer according to claim 11, wherein the first solvent having the boiling point range of 50° C.-150° C. comprises one of an alcohol solvent, an ester solvent, a ketone solvent, and a benzene solvent.

14. The hardened coating layer according to claim 11, wherein the R1 comprises one of formulae:

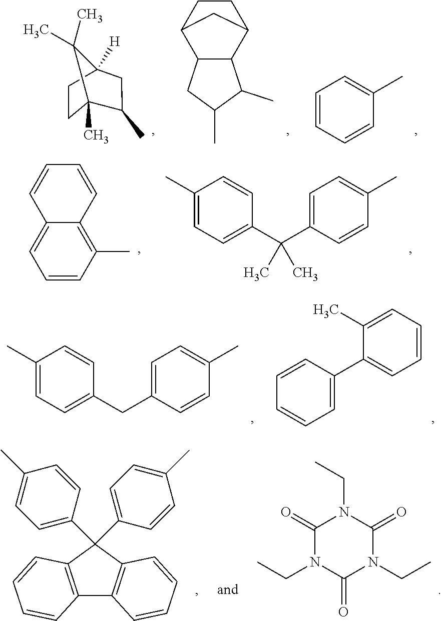

15. The hardened coating layer according to claim 11, wherein the R2 comprises one of formulae:

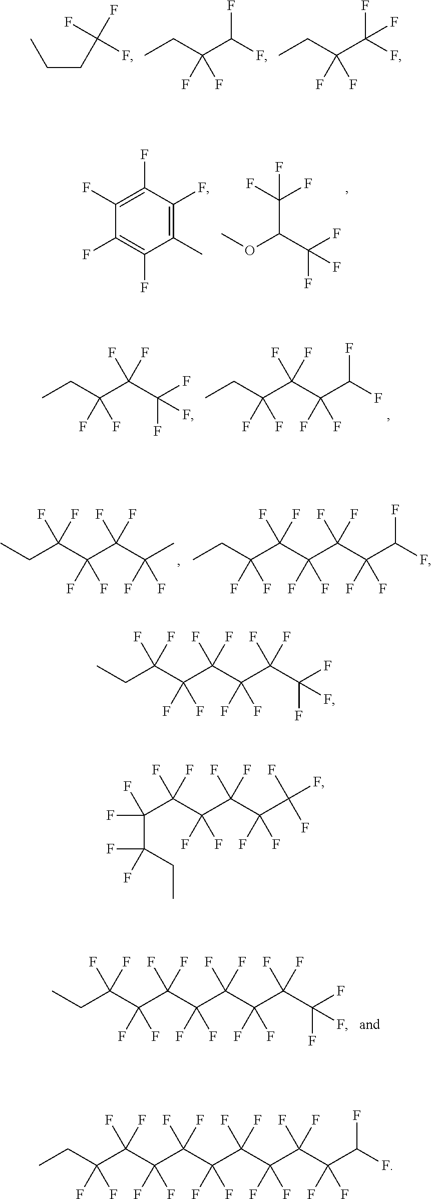

16. The hardened coating layer according to claim 11, wherein the R3 comprises one of formulae:

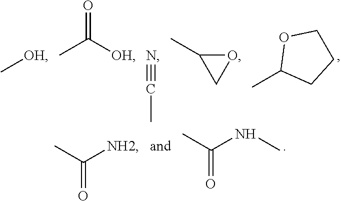

17. A method for manufacturing the hardened coating layer, material of the hardened coating layer being measured in parts by weight, the hardened coating layer comprising:
90 to 100 parts of multifunctional modified silane compounds each comprising: 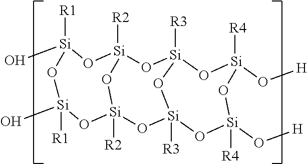
wherein R1 comprises a cyclic rigid structure, R2 comprises a fluorine-containing structure, R3 comprises a polar group, and R4 comprises a polyfunctional (meth) acrylate having three or more (meth)acryloyloxy groups;
5 to 10 parts of photoinitiator; and
900 to 9000 parts of first solvent having a boiling point range of 50° C.-150° C., the method comprising:
mixing the multifunctional modified silane compound, the photoinitiator, and the first solvent having the boiling point range of 50° C.-150° C. to form a hardened coating liquid; and
manufacturing the hardened coating liquid on a substrate to form the hardened coating layer.

18. The method for manufacturing the hardened coating layer according to claim 17, wherein the photoinitiator comprises one of 2-hydroxyacetophenone, alkylaminoacetophenone, benzoin ether, a phosphine oxide compound, benzyl ketal, and dialkoxy phenylethyl ketone photosensitizer.

19. The method for manufacturing the hardened coating layer according to claim 17, wherein the first solvent having the boiling point range of 50° C.-150° C. comprises one of an alcohol solvent, an ester solvent, a ketone solvent, and a benzene solvent.

20. The method for manufacturing the hardened coating layer according to claim 17, wherein the R1 comprises one of formulae: [chemical structure]
